(19) United States
(12) Patent Application Publication
(10) Pub. No.: US 2017/0142778 A1
(43) Pub. Date: May 18, 2017

(54) PLANAR HEATING CLOTH AND METHOD FOR MANUFACTURING SAME

(71) Applicants: Jiwon Lee, Goyang (KR); Eunjung Lee, Gwangju (KR)

(72) Inventors: Jiwon Lee, Goyang (KR); Eunjung Lee, Gwangju (KR)

(21) Appl. No.: 15/322,158

(22) PCT Filed: Nov. 28, 2014
(86) PCT No.: PCT/KR2014/011567

§ 371 Date: Dec. 26, 2016

(30) Foreign Application Priority Data
Jul. 1, 2014 (KR) 10-2014-0082116

(51) Int. Cl. H05B 3/34

(52) U.S. Cl. CPC H05B 3/34; H05B 2214/04

(57) ABSTRACT

The present invention relates to a planar heat cloth and a method for manufacturing the same, and particularly, to a planar heat cloth which is inexpensive and easy to manufacture and has enhanced properties, prevents particle detachment, and generates a large quantity of heat using low electric power. For this purpose, the present invention provides a planar heat cloth comprising a fabric impregnated with a solution having carbon nanotube dispersed therein; and an electrode formed along the fabric. The present invention also provides a method for manufacturing a planar heat cloth, comprising: preparing a solution containing carbon nanotube dispersed therein; forming an electrode along a fabric; and impregnating the fabric with the solution.

### TECHNICAL FIELD

The present invention relates to a planar heat cloth and a method for manufacturing the same, and more particularly, to a planar heat cloth that is inexpensive and easy to make, has improved properties, prevents detachment of particles, and produces a large quantity of heat using low electric power, and a method for manufacturing the planar heat cloth.

### BACKGROUND ART

Generally, planar heat clothes (heat-emitting fabrics) are made by weaving metal wires, carbon fiber, etc., or impregnating cotton fabric with a solution of carbon black or normal active carbon. Making planar heat clothes from metal wires or carbon fiber involves high production cost and difficulty of production and requires high-priced production equipment.

On the other hand, the production of heat clothes from cotton fabric impregnated with carbon black or active carbon requires a large quantity of carbon black or active carbon in order to acquire low resistance because the particles of carbon black or active carbon are globular, so that the heat clothes produced deteriorate in properties, become vulnerable to the change of shape, sensitively causing a corresponding change of resistance, and even has detachment of particles after a coating process. Further, the additional use of a dispersing agent as a result of using an excess of carbon black or active carbon may cause a rise of resistance.

In order to prevent insulation or particle detachment, a binder is generally employed, which inevitably leads to a rise of resistance and viscosity. The increased viscosity obstacles fast formation of a coating of the carbon black or active carbon and deep penetration of the carbon black or active carbon into the cotton fabric.

The prior art related to the planar heat cloth is disclosed in KR Patent No. 621418 under the title of “Method for manufacturing planar heat cloth and planar heat cloth manufactured therefrom”.

### DISCLOSURE OF INVENTION

The present invention is proposed in order to solve the problems with the prior art and it is an object of the present invention to provide a planar heat cloth and a method for manufacturing the same, which planar heat cloth is inexpensive and easy to make, readily maintains low resistance and low viscosity, has improved properties, prevents detachment of particles, and also produces a large quantity of heat using low electric power.

To achieve the object of the present invention, there is provided a planar heat cloth comprising: a fabric impregnated with a solution having carbon nanotube dispersed therein; and an electrode formed along the fabric.

In this regard, the solution comprises a solvent being any one selected from the group consisting of water, ethanol, methanol, N,N-dimethylformamide, N,N-dimethylacetamide, dimethylsulfoxide, N-methylpyrrolidone, hexamethylphosphoramide, acetic acid, and acetone.

Preferably, the solution further comprises a dispersing agent comprising at least one selected from the group consisting of SDS, SDBS, PVP, Triton X-100, and Arabic gum.

Preferably, the solution further comprises an adjuvant including a penetrating agent selected from a surfactant, alum, and caustic soda.

Preferably, an electrode is formed on a fabric impregnated with 70 to 90 wt. % of a solvent, 0.5 to 20 wt. % of a dispersing agent, 0.5 to 20 wt. % of an adjuvant, and 0.5 to 20 wt. % of carbon nanotube.

On the other hand, there is provided a method for manufacturing a planar heat cloth that comprises: (a) preparing a solution containing carbon nanotube dispersed therein; (b) forming an electrode along a fabric; and (c) impregnating the fabric with the solution.

In this regard, the solution-preparing step (a) comprises a first step of mill dispersion for performing refinement in micron size and homogenization; and a second step of tip type second ultrasonic dispersion for performing ultra-refinement in nano size and additional homogenization.

Preferably, the solution-preparing step (a) further comprises performing a bath type ultrasonic dispersion.

Preferably, during the dispersion, cooling is performed by maintaining the solution at a temperature of 20 to 30° C.

Preferably, the electrode-forming step (b) comprises sewing the fabric on a copper electrode using backstitches in a zigzag pattern.

Preferably, the method further comprises, after the impregnating step (c), performing an insulation coating using any one coating method selected from binding coating, laminating coating, and heat transfer coating.

The above-constructed planar heat cloth and its manufacturing method according to the present invention can make useful effects as follows:

Firstly, the planar heat cloth, using a carbon nano-material, is fast and uniform in the transfer of heat and electric current, causes little loss and produces a large quantity of heat using low electric power.

Secondly, the substantial planar heat emission, causing little heat loss, can provide a heating temperature approximately equal to the target temperature.

Thirdly, using a copper electrode stitched between top and bottom fabrics can provide high durability and flexibility for the product.

Fourthly, the use of a carbon nano-material leads to emission of far-infrared radiation in a wide range of wavelength and little electromagnetic waves.

Finally, the impregnation process using a carbon nano-material enables low production cost and mass production.

### BRIEF DESCRIPTION OF DRAWINGS

FIG. 1 is a perspective of a planar heat cloth according to the present invention.

FIG. 2 is a partial enlarged perspective of a planar heat cloth according to the present invention.

FIG. 3 is a flow chart showing a method for manufacturing a planar heat cloth according to the present invention.

### BEST MODES FOR CARRYING OUT THE INVENTION

Hereinafter, the preferred embodiments of the present invention will be described in detail with reference to the accompanying drawings. In the following description, the same reference numerals will be assigned to elements and structures identical to those of the related art and detailed description thereof will be omitted in order to avoid redundancy.

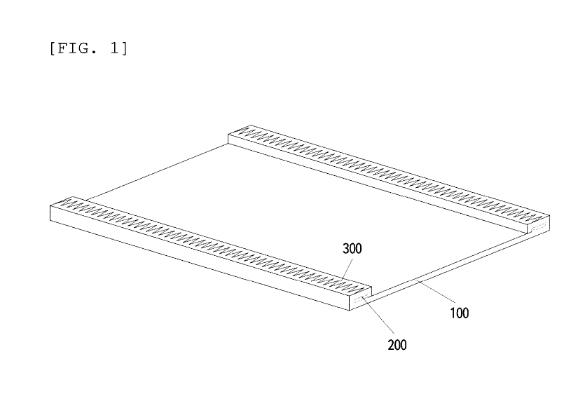

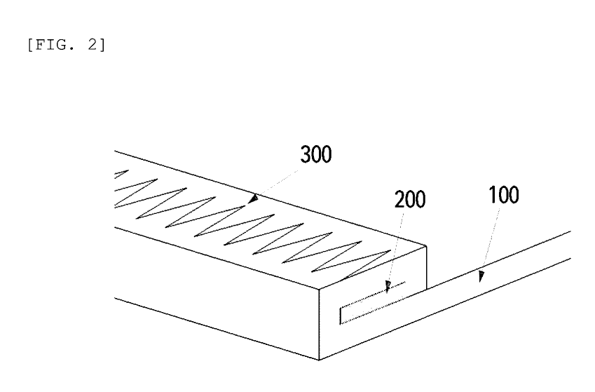

FIG. 1 is a perspective of a planar heat cloth according to the present invention, and FIG. 2 is a partial enlarged perspective of the planar heat cloth according to the present invention.

The planar heat cloth of the present invention comprises, as shown in FIGS. 1 and 2, a fabric 100 used as a basic material and an electrode 200.

Schematically, the present invention employs a simple impregnation process, which uses carbon nanotubes (e.g., SWNT, MWNT, DWNT, etc.) and additionally a dispersing agent and an adjuvant to apply a coating to the planar heat cloth and forms an electrode on both ends of the fabric or along the fabric cloth between both ends of the fabric to generate heat from the whole surface of the fabric.

More specifically, the fabric (fabric material) 100 is impregnated with a solution in which conductive materials, carbon nanotubes (e.g., SWNT, MWNT, DWNT, etc.), are dispersed.

The fabric 100 may be any type of fabric, preferably a fabric being 1 mm or less thick and having 30 counts or less, more particularly a fabric material being 0.2 mm thick and having 10 counts.

The carbon nanotube, when enlarged with an SEM or the like, has a shape of a thread to secure flexibility of the planar heat cloth and causes little particle detachment because they are applied to impregnate and coat the fabric with its entangled structure.

As for the carbon nanotube, MWNT is preferred to SWNT, because it is relatively easy to handle and disperse at high concentration and available for mass production, which leads to low production cost.

The solvent used in the solution may include any one selected from the group consisting of water, ethanol, methanol, N,N-dimethylformamide, N,N-dimethylacetamide, dimethylsulfoxide, N-methylpyrrolidone, hexamethylphosphoramide, acetic acid, and acetone.

And, the solution may further comprise a dispersing agent that comprises at least one material (i.e., a single one or a mixture of several ones) selected from the group consisting of SDS, SDBS, PVP, Triton X-100, and Arabic gum. In particular, PVP displays such an excellent adhesiveness as to be used in the fabrication of an adhesive, so it can be applied to firmly fix the carbon nanotubes to the fabric 100 during the coating process subsequent to the impregnation of the fabric (fabric material) 100.

In addition, the solution further comprises an adjuvant including a penetrating agent selected from a surfactant, alum, and caustic soda.

The solution containing the carbon nanotubes dispersed in a solvent such as water or the like is not easy to penetrate into the fabric 100. As a solution to this problem, a penetrating agent like a surfactant is used as an adjuvant.

But, the surfactant is likely to produce foam, so a small amount of an antifoaming agent may also be used.

The penetrating agent may include alum, caustic soda, etc., which are readily available. The penetrating agent may be any material that helps penetration.

In the plant heat cloth of the present invention according to one embodiment, an electrode is preferably formed on a fabric impregnated with 70 to 90 wt. % of a solvent, 0.5 to 20 wt. % of a dispersing agent, 0.5 to 20 wt. % of an adjuvant, and 0.5 to 20 wt. % of carbon nanotube.

The electrode is made of copper in order to generate heat from the whole surface of the fabric 100 and formed on both ends of the fabric 100 or along the fabric 100 between both ends of the fabric 100.

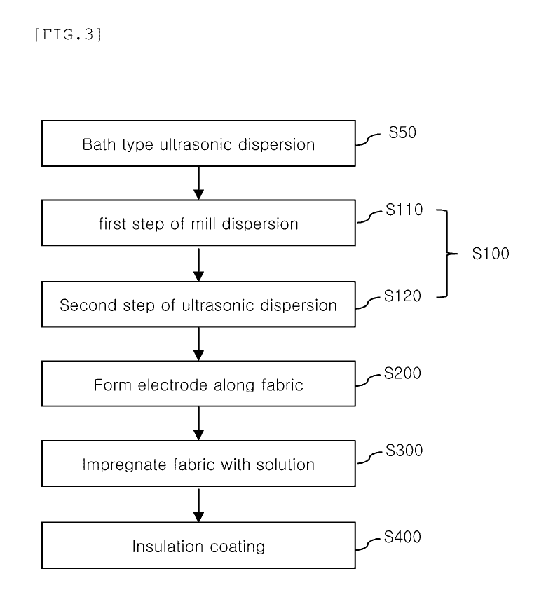

FIG. 3 is a flow chart showing a method for manufacturing a planar heat cloth according to the present invention.

The method for manufacturing a planar heat cloth of the present invention comprises: (S100) preparing a solution containing carbon nanotube dispersed therein; (S200) forming an electrode along a fabric; and (S300) impregnating the fabric with the solution.

In this regard, the solution-preparing step S100 comprises a first step S110 of mill dispersion and a second step S120 of ultrasonic dispersion, unlike the conventional method that involves refinement, homogenization and dispersion of the material according to either one method of ultrasonic dispersion or mill dispersion.

The first step S110 of mill dispersion includes refinement into micron-sized particles and homogenization, and the second step S120 of ultrasonic dispersion includes tip type ultra-refinement into nano-sized particles and additional homogenization. This method can shorten the time and enhance the efficiency.

The second step S120 of ultrasonic dispersion is making the solution flow to achieve uniform dispersion rather than stationary dispersion. Particularly, continuous ultrasonic dispersion is more effective.

At this point, the solution-preparing step S100 may further comprise a step S50 of bath type ultrasonic dispersion prior to the first step S110 of mill dispersion.

Adding the bath type ultrasonic dispersion step S50 prior to the first step S110 of mill dispersion shortens the dispersion time and helps penetration of the dispersing agent and the adjuvant between carbon nanotubes, making the dispersion easier.

When a cooling is performed during the multiple cycles of dispersion, the temperature of the solution may be maintained between 4 to 50° C. The lower temperature below the defined range causes coagulation of the dispersing agent and the adjuvant to deteriorate the dispersion effect;

whereas the higher temperature above the defined range makes the solvent evaporate to form a film on the surface or make the carbon nanotube agglomerate.

More preferably, during the multiple cycles of dispersion, cooling is performed by maintaining the solution at a temperature of 20 to 30° C.

In the step S300 of impregnating the cloth 100 with the solution, the impregnation time may be properly adjusted in the range from 10 seconds to 10 minutes. The drying and hardening temperature after the impregnation step may be controlled between 50° C. and 200° C. When needed, natural drying or cold drying (25 to 80° C.) may precede a second drying/hardening process.

In the step S200 of forming an electrode along the fabric 100, the electrode may be formed on the fabric 100 using a material having low resistance, that is, weaving or sewing a metal wire, conductive paste printing, or conductive sheet or tape, etc.

For the lower production cost, a copper electrode 200 may be used. In order to increase the durability of the copper electrode 200, the copper electrode 200 is attached to the fabric material prior to the coating process and then wrapped with the fabric material.

At this point, the copper electrode 200 properly arranged may be fixed on the fabric by using backstitches in a zigzag pattern with a sewing machine. In order to increase the durability and prevent linear heat emission, the fabric 100 is put over the copper electrode 200 and sewed using backstitches in zigzag. This can secure uniform generation of heat.

When sewing in a zigzag pattern, the backstitch interval may be properly adjusted between 0.5 mm and 50 mm, preferably between 0.8 mm and 1.2 mm.

The zigzag interval may be properly adjusted between 0.5 mm and 50 mm, preferably between 8 mm and 12 mm.

When the copper electrode 200 is attached on both ends of the fabric 100, it is more effective to arrange the copper electrode 200 on both ends of the fabric 100, fold the fabric 100 as much as the width of the copper electrode 200 and then sew using backstitches along the middle of the copper electrode 200.

In this regard, the width of the copper electrode 200 may be properly adjusted between 1 mm and 30 mm, preferably to 10 mm for higher efficiency.

Preferably, the method further comprises an insulation coating step S400 after the impregnation step S300.

After the completion of impregnation (coating), the fabric 100 is subjected to an insulation coating process, which preferably uses any one method selected from binder coating, laminating coating, and heat transfer coating.

The binder coating can neither cause a change in the resistance nor achieve a complete insulation. Hence, the method of the present invention employs laminating coating or heat transfer coating. Advantageously, the laminating film secures transparency, forms a thin coating and enables a change in the tactility and flexibility according to the base film. But, the laminating film is required to have the greater thickness and vulnerable to a strong impact.

The heat transfer coating increases the thickness, but not unlimitedly, has the difficulty to secure transparency and causes high production cost. For a planar heat cloth module used alone, the heat transfer coating method secures the sufficient thickness and protection. For the insertion of a layer to absorb an impact as a mattress pad, the laminating insulation coating method is preferred.

In the case of adding a protective layer even for a general use, the laminating coating method is preferred to the heat transfer coating method in the aspect of production cost and outer appearance.

The film used for the laminating coating method may be any one of PET, PC, PP, PVC, acryl, urethane, Teflon, etc. Particularly, the soft urethane material contributes to high production quality because it has soft texture and creates no wrinkle or no rustling sound while it is bent or moved.

Cutting the base material in proper size can be performed before or after the conductive impregnation (coating) or after the insulation coating. Preferably, the base material may be cut before the conductive impregnation (coating) process.

The driving method for the planar heat cloth of the present invention may use either AC or DC, preferably DC in order to avoid the issue of electromagnetic waves.

The present invention manufactured by the above-described method emits far-infrared radiation due to the use of the carbon material. Even though the heat clothes made of carbon fiber according to the conventional method can also give off far-infrared radiation, it generates an extremely low quantity of far-infrared radiation. But, the present invention can improve this problem with the conventional heat clothes.

The planar heat cloth of the present invention has the whole area of the cotton fabric coated with a carbon material, particularly carbon nanotubes, so it can emit a great quantity of far-infrared radiation to far distance, making the same good effect even when a blanket is put on the heat cloth.

One of the effects of the far-infrared radiation is generating a large quantity of heat using low electric power in a sensory aspect with a rise of body temperature. Actually, the products like a mattress pad using the present invention has the higher heat efficiency at lower electric power than the conventional products such as a hot water mattress pad using a hot wire or a boiler.

Further, the heat source constructed in dots or lines requires extremely high heat above the target temperature in order to increase the entire temperature, resulting in regional burn. Contrarily, the planar heat cloth of the present invention generates heat evenly from the whole surface to reach the target temperature, producing a large quantity of heat and having the temperature of the heat source lower than the target temperature (with not risk of causing burn).

In the present invention, the unexplained reference symbol is the zigzag backstitch line L.

Although the preferred embodiments of the present invention have been described in detail, it is understood that the present invention should not be limited to these exemplary embodiments but various alternatives can be made by those skilled in the art within the spirit and scope of the present invention as hereinafter claimed.

The foregoing description of the preferred embodiments of the invention is presented for purposes or illustration and description only. It is not intended to be exhaustive nor to limit the invention to the precise form. disclosed; and obviously many modifications and variations are possible within the scope of this invention as defined by the accompanying claims.

### INDUSTRIAL APPLICABILITY

The planar heat cloth and its manufacturing method according to the present invention provides a planar heat cloth using a carbon nano-material to achieve fast transfer of heat and electric current, cause little loss of heat and generate a large quantity of heat using low electric power. Further, substantial planar heat generation causes little loss of heat, achieving the temperature of heat approximately as high as the target temperature, secures high durability and flexibility due to the use of a copper electrode fixed between two layers of fabric by sewing. Besides, the present invention uses a carbon nano-material to generate a large quantity of far-infrared radiation over a large area, generates little electromagnetic wave, employs an impregnation process using a carbon nano-material to reduce the production cost and enable mass production.

What is claimed is:

1. A planar heat cloth comprising:
a fabric impregnated with a solution having carbon nanotube dispersed therein; and
an electrode formed along the fabric.

2. The planar heat cloth as claimed in claim 1, wherein the solution comprises a solvent being any one selected from the group consisting of water, ethanol, methanol, N,N-dimethylformamide, N,N-dimethylacetamide, dimethylsulfoxide, N-methylpyrrolidone, hexamethylphosphoramide, acetic acid, and acetone.

3. The planar heat cloth as claimed in claim 1, wherein the solution further comprises a dispersing agent comprising at least one selected from the group consisting of SDS, SDBS, PVP, Triton X-100, and Arabic gum.

4. The planar heat cloth as claimed in claim 1, wherein the solution further comprises an adjuvant including a penetrating agent selected from a surfactant, alum, and caustic soda.

5. A planar heat cloth comprising an electrode formed on a fabric impregnated with 70 to 90 wt. % of a solvent, 0.5 to 20 wt. % of a dispersing agent, 0.5 to 20 wt. % of an adjuvant, and 0.5 to 20 wt. % of carbon nanotube.

6. A method for manufacturing a planar heat cloth, comprising:
(a) preparing a solution containing carbon nanotube dispersed therein;
(b) forming an electrode along a fabric; and
(c) impregnating the fabric with the solution.

7. The method as claimed in claim 6, wherein the solution-preparing step (a) comprises a first step of mill dispersion for performing refinement in micron size and homogenization; and a second step of tip type ultrasonic dispersion for performing ultra-refinement in nano size and additional homogenization.

8. The method as claimed in claim 7, wherein the solution-preparing step (a) further comprises performing a bath type ultrasonic dispersion.

9. The method as claimed in claim 8, wherein during the dispersion, cooling is performed by maintaining the solution at a temperature of 20 to 30° C.

10. The method as claimed in claim 6, wherein the electrode-forming step (b) comprises sewing the fabric on a copper electrode using backstitches in a zigzag pattern.

11. The method as claimed in claim 6, further comprising:
after the impregnating step (c), performing an insulation coating using any one coating method selected from binding coating, laminating coating, and heat transfer coating.
